(19) United States
(12) Patent Application Publication
(10) Pub. No.: US 2023/0129008 A1
(43) Pub. Date: Apr. 27, 2023

(54) DEVICE FOR OBTAINING NEWLY GENERATED OXYGEN FROM ATMOSPHERIC ENVIRONMENT AND APPARATUS FOR PREVENTING LIQUID FROM PASSING THERETHROUGH

(71) Applicant: TAIWAN CARBON NANO TECHNOLOGY CORPORATION, Miaoli County (TW)

(72) Inventors: Kuang-Che LEE, Miaoli County (TW); Chien-Yao HUANG, Miaoli County (TW); Chia-Hung LI, Miaoli County (TW); Chiun-Shian TSAI, Miaoli County (TW); Ting-Chuan LEE, Miaoli County (TW); Chiun-Rung TSAI, Miaoli County (TW)

(21) Appl. No.: 17/973,954

(22) Filed: Oct. 26, 2022

(30) Foreign Application Priority Data
Oct. 27, 2021 (TW) 110139953

(51) Int. Cl. C25B 1/02; B82Y 30/00; C25B 15/08; C25B 13/08; C25B 11/046; C25B 9/19

(52) U.S. Cl. CPC C25B 1/02; B82Y 30/00; C25B 15/08; C25B 13/08; C25B 11/046; C25B 9/19

(57) ABSTRACT

A device for obtaining a newly generated oxygen from an atmospheric environment is disclosed. The device includes a container having an inlet and an outlet, a cathode accommodated in the container and being in contact with an environmental oxygen in the atmospheric environment, an anode accommodated in the container and disposed at a position opposite to the cathode, an electrolyte accommodated in the container and immersing therein the cathode and the anode, a moisture removal unit disposed at the outlet having an outlet position, and a gas permeable element disposed at the outlet, wherein the cathode is disposed at the inlet, and the gas permeable element is disposed at a position closer to the outlet position than the moisture removal unit.

CROSS-REFERENCE TO RELATED APPLICATION AND CLAIM OF PRIORITY

This application claims the benefit of the Taiwan Patent Application No. 110139953, filed on Oct. 27, 2021 at the Taiwan Intellectual Property Office, the disclosures of which are incorporated herein in their entirety by reference.

### FIELD OF THE INVENTION

The present invention is related to a device for obtaining oxygen and a device for preventing a liquid from passing therethrough. Particularly, the present invention is related to a device for obtaining newly generated oxygen from an atomospheric environment and a device for preventing a liquid from passing therethrough.

### BACKGROUND OF THE INVENTION

The common oxygen generator is a continuous-type oxygen supply equipment. The principle of its operation is to use an electric motor (or an air compressor) to input air from the atmospheric environment into the machine body, and pass it through the molecular sieve to separate the oxygen and nitrogen in order to obtain oxygen in high concentration. A device that uses molecular sieves to separate oxygen from the air is called a dry-type oxygen generator. Because this type of oxygen generator operates based on a principle of a metal-air electrochemical cell associated with a redox reaction carried out with the electrodes by consuming the oxygen from the environmental atmosphere at the cathode, the oxygen production efficiency of the dry-type oxygen generator is decreased. Therefore, the material of the electrode and its oxygen-generating method are key factors contributing to the efficiency of oxygen production.

In order to perform a higher-efficiency redox reaction, scientific study is focused on which kind of catalysts are selected as the material for the catalytic layer of the electrode. The activity of the catalyst has a great influence on the performance of the electrode, or so-called air electrode, used for oxygen production. Generally, the air electrode is composed of a catalytic layer containing a catalyst, a conductive current collector, and a gas diffusion membrane. The inventors of the present application focus on how to improve the properties of the catalytic layer to enhance the oxygen production efficiency of the oxygen generator.

Therefore, the present invention provides an electrode manufacturing method to improve the structure of the catalytic layer of the electrode, to increase the surface area of the catalyst involving the reaction, so as to improve oxygen production efficiency.

In addition, because the moisture (or water mist, water vapor, water vapor, mist, aerosol, liquid) in the atmospheric environment varies with weather conditions, the conventional dry-type oxygen generators do not deal with the humid air at its air inlet. Therefore, the oxygen separated from the air may contain a certain amount of moisture. Alternatively, even if the molecular sieve has a material with high water adsorption, such as activated alumina, installed in the dry-type oxygen generator and used to adsorb the moisture, the molecular sieve always has a limitation of saturation of the adsorbed moisture. In view of this, the present application discloses a device for obtaining newly generated oxygen from an atomospheric environment and a device for preventing a liquid from passing therethrough, which can facilitate the removal of the moisture from the air in the atmospheric environment and can output dry oxygen.

In addition, the present application also provides a moisture removing structure (or called a liquid removing structure) suitable for a wet-type oxygen production device containing an electrolyte, which blocks the moisture in the air from the atmospheric environment and let the blocked moisture flow downward under the action of gravity and be separated from the air flow. In another case, after the wet-type oxygen production device separates oxygen from the air, the moisture volatized from the electrolyte can be blocked by a moisture removal unit, so that the blocked moisture can flow back into the electrolyte and will not be output together with the oxygen. Accordingly, without loss due to escape of the moisture, the concentration of the electrolyte can be maintained, thus the service life of this wet oxygen generator is prolonged.

In view of the above, because of the defect in the prior art, the inventors provide the present invention including a structure for removing the moisture and a device for obtaining newly regenerated oxygen from the atmospheric environment to effectively overcome the disadvantages of the prior art. The descriptions of the present invention are as follows:

### SUMMARY OF THE INVENTION

In accordance with one aspect of the present disclosure, a device for obtaining a newly generated oxygen from an atmospheric environment is disclosed. The device includes a container having an inlet and an outlet; a cathode accommodated in the container and being in contact with an environmental oxygen in the atmospheric environment; an anode accommodated in the container and disposed at a position opposite to the cathode; an electrolyte accommodated in the container and immersing therein the cathode and the anode; a moisture removal unit disposed at the outlet having an outlet position; and a gas permeable element disposed at the outlet, wherein the cathode is disposed at the inlet and the gas permeable element is disposed at a position closer to the outlet position than the moisture removal unit.

In accordance with another aspect of the present disclosure, a device for obtaining a newly generated oxygen from an atmospheric environment is disclosed. The device includes an oxygen generating unit; a container having an outlet and accomodating therein the oxygen generating unit; a moisture removal unit disposed in the container; and a gas permeable element disposed at the outlet, wherein the gas permeable element is disposed at a position closer to the outlet than the moisture removal unit.

In accordance with a further aspect of the present disclosure, a device for preventing a liquid from passing therethrough is disclosed. The device includes a liquid removal structure; and a gas permeable element configured to be connected to the liquid removal structure.

The above objectives and advantages of the present invention will become more readily apparent to those ordinarily skilled in the art after reviewing the following detailed descriptions and accompanying drawings, in which:

### BRIEF DESCRIPTION OF THE DRAWINGS

FIG. 1 is an enlarged schematic drawing showing the structure of a catalytic layer of an electrode according to an embodiment of the present invention;

FIG. 2 is a flow chart showing the production steps of the electrode including the catalytic layer according to an embodiment of the present invention;

FIG. 3A is a schematic diagram showing a structure of an electrode according to an embodiment of the present invention;

FIG. 3B is a schematic drawing showing a structure of an electrode according to another embodiment of the present invention;

FIG. 4 is a schematic drawing showing the structure of the device for obtaining a newly generated oxygen used for the test, each device been configured with the electrodes made of one selected from Examples 1 to 5 according to the present invention and a Comparative Example;

FIG. 5 is a graph showing the curves of the current densities per unit area changing with time using the electrode of Examples 1 to 5 according to the present invention and the Comparative Example;

FIG. 6A is a photograph of a surface of a cathode, showing the contact angles of water droplets applied thereon, in which the cathode has the material according to an embodiment of the present invention, on which surface water droplets are applied to test the contact angle property of the cathode surface;

FIG. 6B is a schematic drawing showing the state of the contact angle of a water droplet on the surface of the cathode of FIG. 6A;

FIG. 7 is a schematic drawing showing a wet-type device for obtaining newly generated oxygen from an atmospheric environment according to an embodiment of the present invention;

FIG. 8 is a schematic drawing showing a device for preventing a liquid passing therethrough according to an embodiment of the present invention;

FIG. 9 is a schematic drawing showing a dry-type device for obtaining newly generated oxygen from an atmospheric environment according to an embodiment of the present invention;

FIG. 10 is a schematic drawing showing a dry-type device for obtaining newly generated oxygen from an atmospheric environment according to another embodiment of the present invention;

FIG. 11 is a graph showing the amounts of the oxygen generated using the wet-type device for obtaining newly generated oxygen from the atmospheric environment under the conditions for the moisture removal test according to the present invention; and

FIG. 12 is a graph showing moisture loss curves of the moisture removal test using the wet-type device for obtaining newly generated oxygen from the atmospheric environment according to the present invention.

### DETAILED DESCRIPTION OF THE PREFERRED EMBODIMENTS

Please refer to all figures of the present invention when reading the following detailed description, wherein all Figures of the present invention demonstrate different embodiments of the present invention by showing examples, and help the skilled person in the art to understand how to implement the present invention. The present examples provide sufficient embodiments to demonstrate the spirit of the present invention, each embodiment does not conflict with the others, and new embodiments can be implemented through an arbitrary combination thereof, i.e., the present invention is not restricted to the embodiments disclosed in the present specification.

Unless there are other restrictions defined in the specific example, the following definitions apply to the terms used throughout the specification.

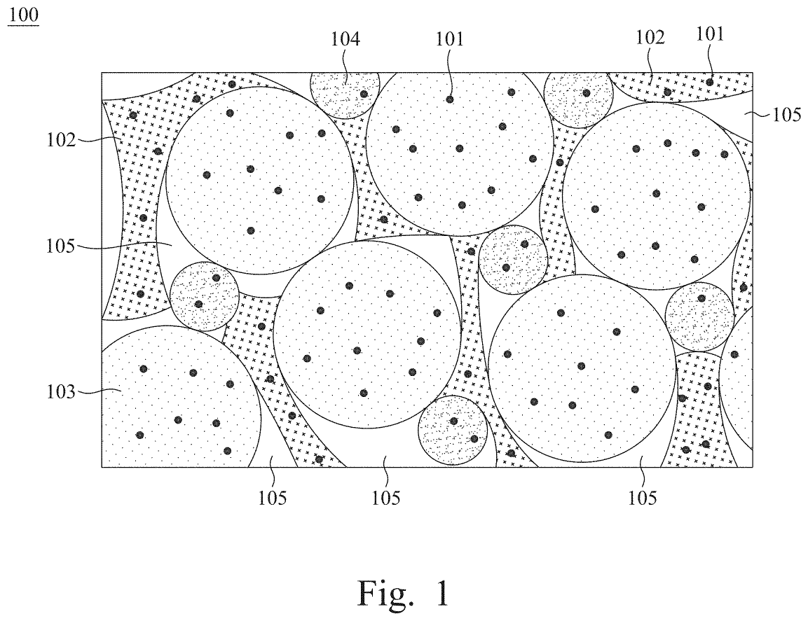

Please refer to FIG. 1, which is an enlarged schematic drawing showing the structure of a catalytic layer of an electrode according to an embodiment of the present invention. As shown in FIG. 1, the catalytic layer 100 mainly includes a first conductive agent 101, a first adhesive 102, a first catalyst having a first average particle size (or a relatively large particle size catalyst) 103 and a second catalyst having a second average particle size (or a relatively small particle size catalyst) 104. The first conductive agent 101is uniformly distributed in the adhesive 102, and is also distributed on the surfaces of the first catalyst 103 and the second catalyst 104. The first adhesive 102 binds the at first catalyst 103 and the second catalyst 104 together, but even so, there are passages 105 between the first catalysts 103 and the second catalysts 104, between the first catalyst 103 and the second catalyst 104, for fluid passing therethrough. The passages 105 have widths or heights with different sizes. According to an embodiment of the present invention, because the catalytic layer 100 has catalysts of different average particle sizes in a mixed form, there will be larger passages resulting from the larger particle size catalyst and small passages resulting from the smaller particle size catalyst. Accordingly, the passages are densly distributed in the catalytic layer. In this case, the total surface areas of the catalysts in the catalytic layer can be increased, and the efficiency of the associated catylic reaction is increased, and thus the oxygen production efficiency is improved.

The composition of the catalytic layer 100 according to an embodiment of the present invention can be mainly divided into a first catalyst 103 having a relatively large particle size 103 and a second catalyst 104 having a relatively small particle size, wherein the term “particle size” means “an average particle size”. The average particle size can refer to the D50 value (ie, the median size value in a particle size distribution) or the arithmetic mean, which can be measured and provided by, for example, a laser particle counter known in the art. The catalyst having an average particle size can be selected by those skilled in the art depending on their requirements. In order to keep stable quality of the product obtained from a catalytic reaction, the catalysts having various particle sizes will be screened with a specific mesh in advance to obtain the catalysts having a proper particle size distribution according to the requirements. In addition, because the shapes of the catalyst particles of the catalyst is not consistent, the particle sizes are calculated based on the long diameter of the particles. According to an embodiment of the present invention, the first average particle size is in the range of 150-270 μm, and the second average particle size is in the range of 5-50 μm. The first average particle size is 3-54 times of the second average particle size.

According to an embodiment of the present invention, the first catalyst 103 and the second catalyst 104 in the catalytic layer 100 has a material selected from the group consisting of ruthenium dioxide, iridium dioxide, manganese dioxide, cobalt oxide, cobalt tetroxide, nickel hydroxide, nickel oxide, iron oxide, tungsten trioxide, vanadium pentoxide and palladium oxide.

According to an embodiment of the present invention, the first adhesive 102 has a material selected from a group consisting of polytetrafluoroethylene (PTFE), perfluoroethylene propylene copolymer (FEP) and polyvinylidene fluoride (PVDF). The first conductive agent 101 has a material selected from a group consisting of carbon black, acetylene black and carbon nanofibers

The material of the adhesive 102 is selected from polytetrafluoroethylene (PTFE), perfluoroethylene propylene copolymer (FEP) or polyvinylidene fluoride (PVDF). The material of the conductive agent 101 is selected from carbon black, acetylene black or carbon nanofibers.

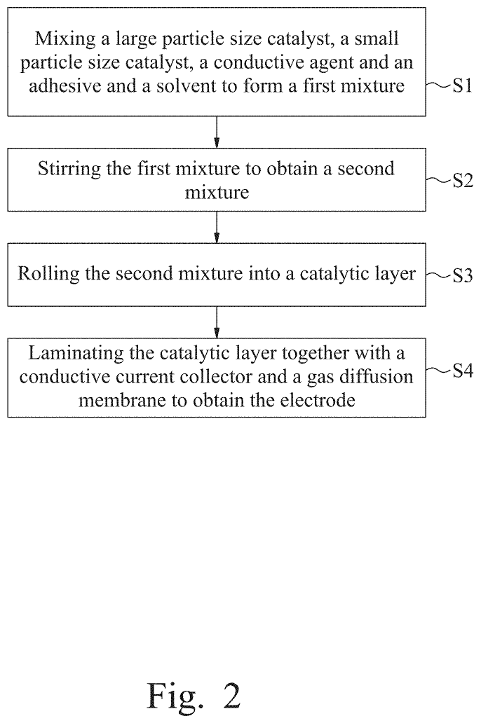

FIG. 2 is a flow chart showing the production steps of the electrode including the catalytic layer according to an embodiment of the present invention. As shown in FIG. 2, the manufacturing method includes the steps of: Step S1, mixing a large particle size catalyst, a small particle size catalyst, a conductive agent and an adhesive and a solvent to form a first mixture; Step S2, stirring the first mixture to obtain a second mixture; and Step S3, rolling the second mixture into a catalytic layer. The above-mentioned catalytic layer 100 can be obtained. In addition, the solvent can be water, an alcohol, or a combination thereof. Then, in order to further manufacture an electrode from the catalytic layer 100, the solvent is evaporated and exhausted during the electrode manufacturing process, thereby making it easier to generate the fluid passage 105 consisting of gaps and pores in the catalytic layer 100. After that, perform Step S4 to laminate the catalytic layer together with a conductive current collector and a gas diffusion membrane to obtain the electrode.

The amount of the conductive agent added in the above Step S1 does not exceed half of the total weight of the first mixture, preferably within the range of 20-50%, more preferably within the range of 28-46%. The conductive agent can enhance the conductivity of the electrode. If too much of the conductive agent is added, the content of the catalyst will be reduced, and the reaction ability will deteriorate. For the catalyst added in the above Step S1, the weight ratio of the large particle size catalyst to the small particle size catalyst is 10:1-1:10, preferably 5:1-1:5.

The difference between the mixing Step S1 and the stirring Step S2 is that Step S1 is a rough mixing and does not require high uniformity, while the Step S2 is performed to achieve high uniformity of the mixture. Therefore, in the mixing Step S1, the rotating speed can be set at 50-800 rpm, preferably 100-700 rpm, more preferably 150-600 rpm. A mixer (blade shear force mixer) commonly used by those in the art can be used for manufacturing the first mixture. A planetary mixer (also known as a gravity centrifugal mixer) can be used for the stirring Step S2, and the rotation speed is set in the range of 200-2000 rpm, preferably 400-1900 rpm, more preferably 500-1400 rpm, to manufacture the second mixture. In addition, Step S2 is not limited to using a planetary mixer, and can also be performed by a blade shearing mixer, as long as the purpose of uniform distribution of materials can be achieved.

A rolling machine commonly used by those in the art can be used for the rolling Step S3, wherein the rotation speed is set in the range of 1-30 rpm, preferably 2-28 rpm, more preferably 4-26 rpm, and the temperature of the roller is set below 150° C., preferably 15-100° C., more preferably 20-80° C.

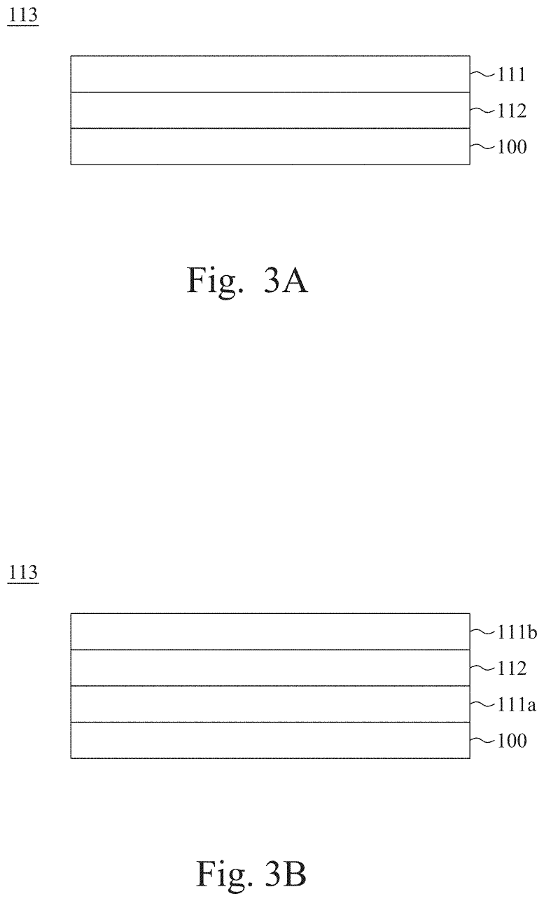

FIG. 3A is a schematic diagram showing an electrode structure according to an embodiment of the present invention. FIG. 3B is a schematic diagram showing an electrode structure according to another embodiment of the present invention. As shown in FIG. 3A, the cathode 113 is formed by laminating the conductive current collector 112 on the catalytic layer 100, and laminating the gas diffusion membrane 111 on the conductive current collector 112. In addition, as shown in FIG. 3B, the first gas diffusion membrane 111a is laminated on the catalytic layer 100, followed by the conductive current collector 112 is laminated on the first gas diffusion membrane 111a, and finally the second gas diffusion membrane 111b is laminated on the conductive current collector 112. The electrode of the four-layer structure can provide a more stable reaction than that of the three-layer structure because the gas diffusion membrane 111 has a better bond with the conductive current collector 112.

The function of the conductive current collector 112 is to concentrate the current, fix the catalytic layer and support the electrode structure, and the conductive current collector 112 is a metal mesh or foam having a material selected from a group consisting of stainless steel, nickel, titanium and copper. The functions of the gas diffusion membranes 111, 111a and 111b are to allow oxygen to pass therethrough and prevent the electrolyte from outflowing, and the gas diffusion membranes 111, 111a and 111b are made of the same materials as the conductive agent 101 and the adhesive 102. That is, the gas diffusion membranes 111, 111a and 111b are made of the conductive agent and the adhesive. The conductive agent is selected from one of or at least one of, for example, carbon black, acetylene black, and carbon nanofibers. The adhesive is selected from one of polytetrafluoroethylene (PTFE), perfluoroethylene propylene copolymer (FEP) and polyvinylidene fluoride (PVDF). The gas diffusion membranes 111, 111a and 111b are manufactured by mixing, stirring and rolling. The steps for manufacturing the gas diffusion membranes 111, 111a and 111b are similar to Steps S1-S3, except that no catalyst is added, and the mixing ratio can be adjusted by one skilled in the art according to needs. The ratio of the conductive agent 101 is preferably higher than that of the adhesive 102. In the gas diffusion membrane 111, the ratio of the adhesive 102 is higher than that of the catalyst layer 100.

Based on the above-mentioned manufacturing method of the catalyst layer 100 of the present invention, relevant embodiments are proposed as follows.

TABLE 1

| | Material weight | |
|---|---|---|
| Embodiment 1 | percentage | Actual weight |
| Catalyst | MnO₂ 270 μm, 20% | MnO₂ 270 μm, 45 g |
| | MnO₂ 5 μm, 4% | MnO₂ 5 μm, 9 g |
| Conductive agent | XC72 46% | XC72, 103.5 g |
| Adhesive | PTFE 30% | PTFE, 67.5 g |
| Solvent | Water and Ethanol | Ethanol 112 g |
| | | Water 665 g |

Regarding Embodiment 1 of the present invention, it is prepared according to the ratio of Table 1 above. Specifically, 45 g of MnO₂ with an average particle size of 270 μm, 9 g of MnO₂ with an average particle size of 5 pm, 103.5 g of XC72R and 67.5 g of PTFE are mixed with 112 g of 95% ethanol and 665 g of water and stirred by the DLH DC mixer (YOTEC CORPORATION, MRB-3500L) at 200 rpm for 10 minutes, and a gelatinous first mixture is produced after thorough mixing. The gelatinous first mixture is then stirred by the planetary mixer (THINKY CORPORATION) at 1900 rpm for 5 minutes to obtain an agglomerated second mixture. The agglomerated second mixture is then rolled into a catalytic layer with a thickness of 0.78 mm using the roller compactor (EKTRON TEK CO., LTD., EKT-2100SLM) at 25° C. and 50 rpm. Finally, the catalytic layer is laminated with a conductive current collector and a gas diffusion membrane (thickness of 1.2 mm) to obtain an electrode (or a cathode) with a thickness of 1.87 mm

TABLE 2

| | Material weight | |
|---|---|---|
| Embodiment 2 | percentage | Actual weight |
| Catalyst | MnO₂ 270 μm, 35% | MnO₂ 270 μm, 78.75 g |
| | MnO₂ 50 μm, 7% | MnO₂ 50 μm, 15.75 g |
| Conductive agent | XC72R 25% | XC72R, 56.25 g |
| | VGCF-H 3% | VGCF-H, 6.75 g |
| Adhesive | PTFE 30% | PTFE, 67.5 g |
| Solvent | Water and Ethanol | Ethanol 112 g |
| | | Water 665 g |

Regarding Embodiment 2 of the present invention, it is prepared according to the ratio of Table 2 above. Specifically, 78.75 g of MnO₂ with an average particle size of 270 μm, 15.75 g of MnO₂ with an average particle size of 50 μm, 56.25 g of XC72R, 6.75 g of VGCF-H and 67.5 g of PTFE are mixed with 112 g of 95% ethanol and 665 g of water and stirred by the DLH DC mixer (YOTEC CORPORATION, MRB-3500L) at 200 rpm for 10 minutes, and a gelatinous first mixture is produced after thorough mixing. The gelatinous first mixture is then stirred by the planetary mixer (THINKY CORPORATION) at 1900 rpm for 5 minutes to obtain an agglomerated second mixture. The agglomerated second mixture is then rolled into a catalytic layer with a thickness of 0.78 mm using the roller compactor (EKTRON TEK CO., LTD., EKT-2100SLM) at 25° C. and 50 rpm. Finally, the catalytic layer is laminated with a conductive current collector and a gas diffusion membrane (thickness of 1.2 mm) to obtain an electrode (or a cathode) with a thickness of 1.87 mm

TABLE 3

| | Material weight | |
|---|---|---|
| Embodiment 3 | percentage | Actual weight |
| Catalyst | MnO₂ 150 μm, 35% | MnO₂ 150 μm, 78.75 g |
| | MnO₂ 5 μm, 7% | MnO₂ 5 μm, 15.75 g |
| Conductive agent | XC72 38% | XC72, 85.5 g |
| Adhesive | PTFE 20% | PTFE, 45 g |
| Solvent | Water and Ethanol | Ethanol 114 g |
| | | Water 662 g |

Regarding Embodiment 3 of the present invention, it is prepared according to the ratio of Table 3 above. Specifically, 78.75 g of MnO₂ with an average particle size of 150 μm, 15.75 g of MnO₂ with an average particle size of 5 μm, 85.5 g of XC72R and 45 g of PTFE are mixed with 114 g of 95% ethanol and 662 grains of water and stirred by the DLH DC mixer (YOTEC CORPORATION, MRB-3500L) at 200 rpm for 10 minutes, and a gelatinous first mixture is produced after thorough mixing. The gelatinous first mixture is then stirred by the planetary mixer (THINKY CORPORATION) at 1900 rpm for 5 minutes to obtain an agglomerated second mixture. The agglomerated second mixture is then rolled into a catalytic layer with a thickness of 0.78 mm using the roller compactor (EKTRON TEK CO., LTD., EKT-2100SLM) at 25° C. and 50 rpm. Finally, the catalytic layer is laminated with a conductive current collector and a gas diffusion membrane (thickness of 1.2 mm) to obtain an electrode (or a cathode) with a thickness of 1.87 mm

TABLE 4

| | Material weight | |
|---|---|---|
| Embodiment 4 | percentage | Actual weight |
| Catalyst | MnO₂ 150 μm, 30% | MnO₂ 150 μm, 67.5 g |
| | MnO₂ 50 μm, 6% | MnO₂ 50 μm, 13.5 g |
| Conductive agent | XC72 44% | XC72, 99 g |
| Adhesive | PTFE 20% | PTFE, 45 g |
| Solvent | Water and Ethanol | Ethanol 114 g |
| | | Water 662 g |

Regarding Embodiment 4 of the present invention, it is prepared according to the ratio of Table 4 above. Specifically, 67.5 g of MnO₂ with an average particle size of 150 pm, 13.5 g of MnO₂ with an average particle size of 50 pm, 99 g of XC72R and 45 g of PTFE are mixed with 114 g of 95% ethanol and 662 g of water and stirred by the DLH DC mixer (YOTEC CORPORATION, MRB-3500L) at 200 rpm for 10 minutes, and a gelatinous first mixture is produced after thorough mixing. The gelatinous first mixture is then stirred by the planetary mixer (THINKY CORPORATION) at 1900 rpm for 5 minutes to obtain an agglomerated second mixture. The agglomerated second mixture is then rolled into a catalytic layer with a thickness of 0.78 mm using the roller compactor (EKTRON TEK CO., LTD., EKT-2100SLM) at 25° C. and 50 rpm. Finally, the catalytic layer is laminated with a conductive current collector and a gas diffusion membrane (thickness of 1.2 mm) to obtain an electrode (or a cathode) with a thickness of 1.87 mm

TABLE 5

| | Material weight | |
|---|---|---|
| Embodiment 5 | percentage | Actual weight |
| Catalyst | MnO₂ 150 μm, 6% | MnO₂ 150 μm, 13.5 g |
| | MnO₂ 50 μm, 30% | MnO₂ 50 μm, 67.5 g |
| Conductive agent | XC72R 31% | XC72R, 69.75 g |
| | VGCF-H 3% | VGCF-H, 6.75 g |
| Adhesive | PTFE 30% | PTFE, 67.5 g |
| Solvent | Water and Ethanol | Ethanol 112 g |
| | | Water 665 g |

Regarding Embodiment 5 of the present invention, it is prepared according to the ratio of Table 5 above. Specifically, 13.5 g of MnO₂ with an average particle size of 150 pm, 67.5 g of MnO₂ with an average particle size of 50 μm, 69.75 g of XC72R, 6.75 g of VGCF-H and 67.5 g of PTFE are mixed with 112 g of 95% ethanol and 665 g of water and stirred by the DLH DC mixer (YOTEC CORPORATION, MRB-3500L) at 200 rpm for 10 minutes, and a gelatinous first mixture is produced after thorough mixing. The gelatinous first mixture is then stirred by the planetary mixer (THINKY CORPORATION) at 1900 rpm for 5 minutes to obtain an agglomerated second mixture. The agglomerated second mixture is then rolled into a catalytic layer with a thickness of 0.78 mm using the roller compactor (EKTRON TEK CO., LTD., EKT-2100SLM) at 25° C. and 50 rpm. Finally, the catalytic layer is laminated with a conductive current collector and a gas diffusion membrane (thickness of 1.2 mm) to obtain an electrode (or a cathode) with a thickness of 1.87 mm.

TABLE 6

| Comparative | Material weight | |
|---|---|---|
| Example | percentage | Actual weight |
| Catalyst | MnO₂ 150 μm, 20% | MnO₂ 150 μm, 45.0 g |
| Conductive agent | XC72R 50% | XC72R, 112.5 g |
| Adhesive | PTFE 30% | PTFE, 67.5 g |
| Solvent | Water and Ethanol | Ethanol 112 g |
| | | Water 665 g |

Regarding a comparative example of a single average particle size of the present invention, it is prepared according to the ratio of Table 6 above. Specifically, 45.0 g of MnO₂ with a single average particle size of 150 μm (as in the above-mentioned Embodiments 1-5, the single average particle size refers to the D50 value calculated by a laser particle size analyzer known in the art), 112.5 g of XC72R, 67.5 g of PTFE, 112 g of 95% ethanol and 665 g of water are mixed by the DLH DC mixer (YOTEC CORPORATION, MRB-3500L) at 200 rpm for 10 minutes, and a gelatinous first mixture is produced after thorough mixing. The gelatinous first mixture is then stirred by the planetary mixer (THINKY CORPORATION) at 1900 rpm for 5 minutes to obtain an agglomerated second mixture. The agglomerated second mixture is then rolled into a catalytic layer with a thickness of 0.78 mm using the roller compactor (EKTRON TEK CO., LTD., EKT-2100SLM) at 25° C. and 50 rpm. Finally, the catalytic layer was laminated with a conductive current collector and a gas diffusion membrane (thickness of 1.2 mm) to obtain an electrode (or a cathode) with a thickness of 1.87 mm.

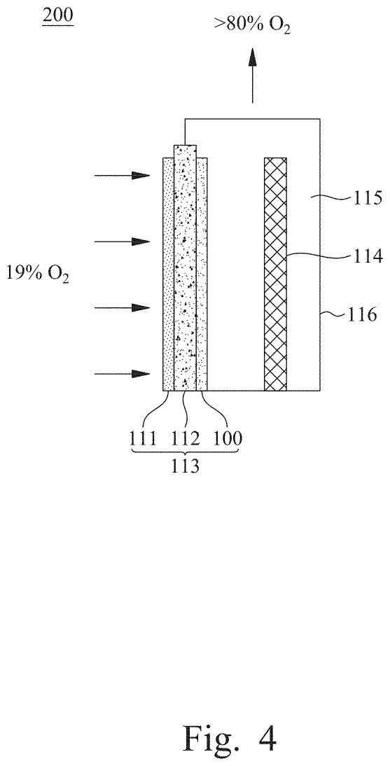

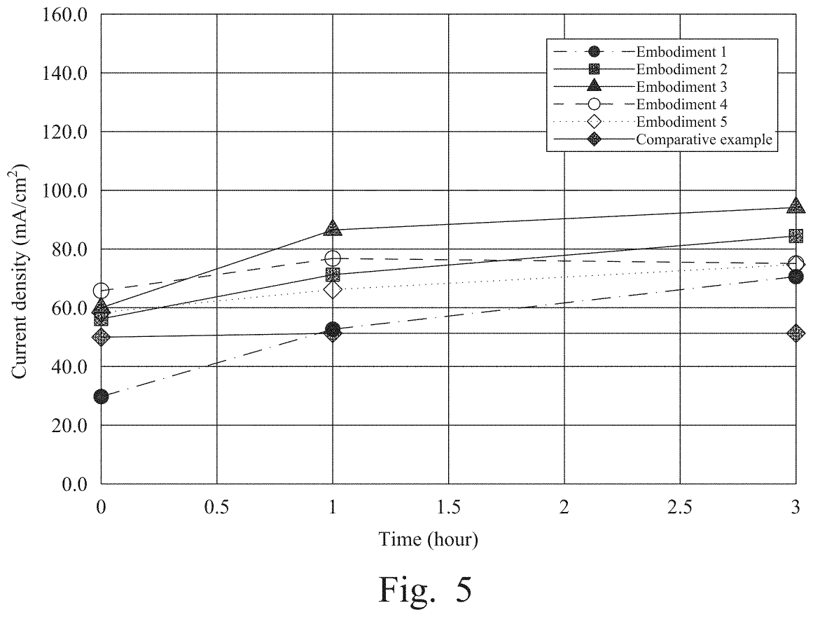

FIG. 4 is a schematic diagram showing the structure of an oxygen generating apparatus with the electrodes of the embodiments 1-5 and the comparative example, to perform the test. In order to test the performance of the electrodes made of different materials, a simplified oxygen generating apparatus 200 is proposed. As shown in FIG. 4, in a container 116 having an electrolyte 115 (30% sodium hydroxide), a part of the cathode 113 is manufactured according to the manufacturing steps of the above-mentioned embodiments and the comparative example, and the nickel mesh used as the anode 114 is placed inside the container 116. In the container 116, the catalytic layer 100 of the cathode 113 and the anode 114 are soaked with the electrolyte 115. The gas diffusion layer 111 of the cathode 113 is disposed outside the container 116, and the catalytic layer 100 is inside the container 116, so that oxygen in the atmosphere can enter the container 116 through the gas diffusion layer 111. When a voltage is applied, the oxygen generating apparatus 200 allows oxygen from the atmosphere to generate a higher concentration oxygen via the electrochemical reaction of the catalytic layer 100 with the anode 114, which can concentrate only 19% oxygen in the atmosphere to more than 80% oxygen in the oxygen generating apparatus 200. The surface areas of the cathode 113 and the anode 114 are 100 cm², which can be used in portable oxygen generating apparatus. During the test, a voltage of 1V was applied to the electrode to measure the current value, and the current value was divided by the area to obtain the current density value. The results are shown in FIG. 5.

FIG. 5 is a line graph showing the changes of the relationship between the current density per unit area and time of the embodiments 1-5 and the comparative example of the present invention. The higher the current density per unit area, the better the electrochemical reaction capability, and thus the oxygen production efficiency of the electrodes of the embodiments of the present invention can be evaluated. This test is carried out by combining the cathodes of the embodiments 1-5 with potassium hydroxide electrolyte and anode Ni mesh. It can be seen in FIG. 5 that the current densities per unit area of the embodiments 1-5 obtained by the catalysts with double average particle sizes of the present invention are all larger than that obtained by the catalysts with the single average particle size in the comparative example. Although the performance of Embodiment 1 is not as good as that of the comparative example in the first hour, the effect is gradually increased after 1 hour, and it is close to the performances of embodiments 4 and 5 after 3 hours. That is to say, because the ratio of adhesive to catalyst is different, the starting value of each Embodiment is also different, but the final result is still better than the catalyst with the single average particle size range. It can be seen in FIG. 5 that the performance of embodiment 3 is obviously the best.

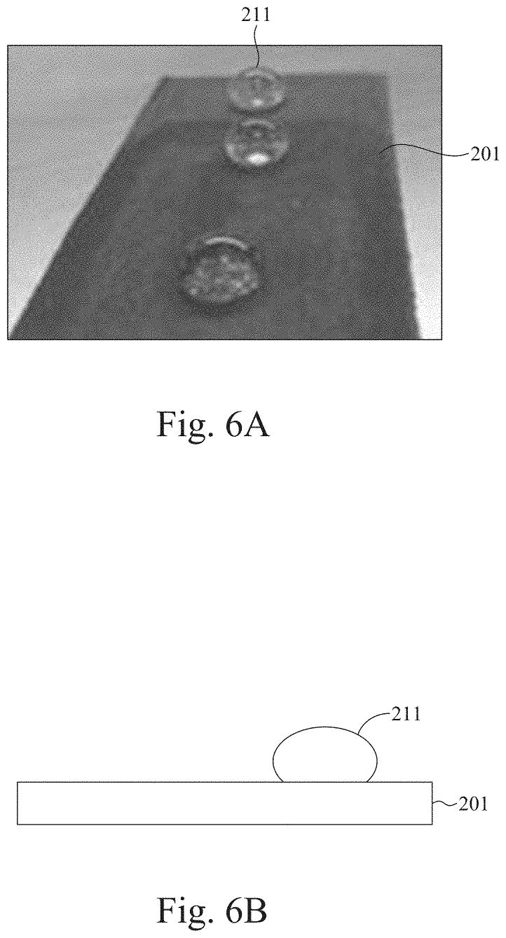

FIG. 6A is a photograph of a surface of a cathode, showing the contact angle of a water droplet applied thereon, in which the cathode has the material according to an embodiment of the present invention, on which surface a water droplet is applied to test the contact angle property of the cathode surface, and FIG. 6B is a schematic drawing showing the state of the contact angle on the surface of the cathode of FIG. 6A. The composition of the cathode material is shown in Table 7 below.

TABLE 7

| | |
|---|---|
| catalyst | manganese dioxide (MnO2) 270 μm: 20% |
| | manganese dioxide (MnO2) 5 μm: 4% |
| conductive agent | carbon black, XC72: 46% |
| adhesive | Polytetrafluoroethylene (PTFE): 30% |
| solvent | water |

It can be seen from FIGS. 6A and 6B that the contact angle of the water droplet 211 formed on the surface of the cathode 201 made of the cathode material according to an embodiment of the present invention is extremely large, and the water droplet 211 has a granular shape and looks like a bead. This phenomenon will be applied to the examples and explained in the following paragraphs.

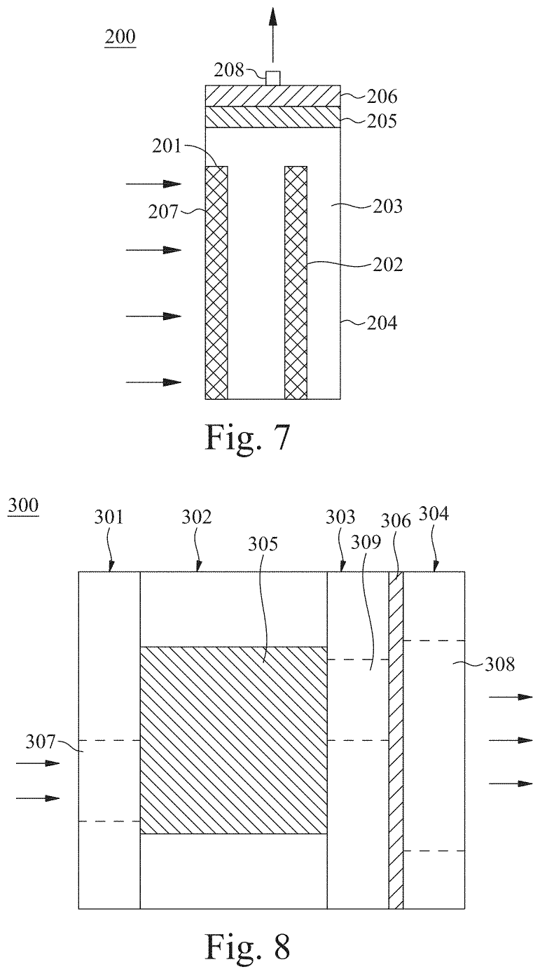

FIG. 7 is a schematic drawing showing a wet-type device for obtaining newly generated oxygen from an atmospheric environment according to an embodiment of the present invention. As shown in FIG. 7, the device 200 for obtaining newly regenerated oxygen from the atmospheric environment has a container 204. The container 204 has an inlet 207 and an outlet 208. The inlet 207 allows an inflow (as indicated by the arrows in FIG. 7) of the air in the atmospheric environment, and the outlet 208 allows an outflow (as indicated by an arrow in FIG. 7) of the newly generated oxygen. The container 204 accommodates the electrolyte 203, the cathode 201, the anode 202 disposed at a position opposite to the cathode 201, a moisture removal unit (or called a liquid removal structure) disposed at the outlet having an outlet position and a gas permeable element (or called an air permeable/penetratable element) 206. The cathode 201 is disposed at a position close to the inlet 207, and can even be disposed tightly close to the inlet 207. The electrolyte 203 substantially immerses the cathode 201 and the anode 202 and serves as an electrically conductive medium between the cathode 201 and the anode 202. When the cathode 201 is disposed next to the inlet 207, not all of the cathode 201 but a part of it is immersed in the electrolyte 203. In this case, at least a part of the surface of the cathode 201 facing the inlet 207 is in direct contact with an environmental oxygen in the air from the atmospheric environment. Inside the cathode 201, there are passages consisting of gaps and pores (hereinafter called “passages”) formed by the particles of the catalyst including the large and small particles of different size distributions, and the material used in the cathode 201 includes a hydrophobic adhesive having a material being, for example, a teflon material such as PTFE, and so on, which adheres to at least a part of each of the surfaces of the large and small particles of the catalyst, i.e. the surfaces of the passages. The liquid (such as moisture) contained in the electrolyte 203 will have an extremely large contact angle with any surface of the passages inside the cathode 201 and will form a granular shape because of the hydrophobicity of the particles of the catalyst adhered to the adhesive. The state of the contact angle of the liquid will look like the ones as shown in FIGS. 6A and 6B. Therefore, although the electrolyte 203 may pass through the local passages at a position in the cathode 201 closer or closest to the electrolyte 203, it will not eventually penetrate to the farther passages at a position in the cathode 201 farther or farthest from the electrolyte 203 (ie, a position closer or closest to the inlet 207). Therefore, the material of the cathode 201 according to the present invention can prevent the electrolyte 203 from flowing out of the inlet 207 through the cathode 201.

According to an embodiment of the present invention, the gas permeable element 206 is disposed at a position closest to the outlet 208 having an outlet position, that is, the gas permeable element 206 is disposed at a position closer to the outlet position than the moisture removal unit 205. Because the device 200 for obtaining newly generated oxygen from the atmospheric environment has the electrolyte 203, is called a wet-type device for obtaining newly generated oxygen from the atmospheric environment.

The device 200 for obtaining regenerated oxygen from the atmospheric environment being wet-type further includes a power supply (not shown in the figure). The power supply is electrically connected to the cathode 201 and the anode 202. The cathode 201 adsorbs an environmental oxygen in the atmospheric environment, and the adsorbed environmental oxygen undergoes a first electrochemical reaction, which is a reduction reaction at the cathode 201 to generate a hydroxide ion; and a hydroxide ion undergoes a second electrochemical reaction, which is an oxidation reaction, at the anode 202 to generate the newly generated oxygen. The Applicants have found that the half-reactions that occur at each of the cathode and anode are as follows, respectively.

a reduction reaction occurring at the cathode: O₂+H₂O+4 e⁻→4OH⁻
an oxidation reaction occurring at the anode: 4 OH⁻−4e⁻→O₂↑+2H₂O
If an electrode with an area of 100 cm² is used and a condition including a potential difference (or voltage) of about 1 V and the current density of 100 mA/cm² is applied for a test, the amount of oxygen generated can reach 35 mL/min. It can be realized that a portable wet-type device for obtaining newly generated oxygen from the atmospheric environment is acquired accordingly. In addition, because the applied voltage is lower than a minimum potential difference of 1.23 volts required for the electrolysis of water, the water in the electrolyte will not be electrolyzed at the same time when the electrochemical reactions occur, the water in the electrylyte is not lost. Furthermore, the risk of the generation of hydrogen resulting from the electrolysis of water can be avoided.

The electrolyte 203 includes one of salts of alkali metals, liquid electrolytes or solid electrolytes of the ionic liquids. The salts of alkali metals include, but are not limited to, hydroxides, carbonates, halides, sulfates, nitrates or thiosulfates, etc., such as NaOH, KOH or K₂CO₃, KI, Na₂SO₄ or K₂SO₄, NaNO₃, Na₂S₂O₃, etc.

The function of the gas permeable element 206 is water-resistant and gas permeable, and has a material being a first teflon material selected from a group consisting of PTFE, FEP and PVDF. The gas permeable element can also be formed as a membrane and installed in a form of a permeable membrane. The applicable pore size of a gas permeable elements can be selected from a range of 0.1 μm to 10 μm and thicknesses of which can be selected from a range of 30 um to 300 um

The moisture removal unit 205 can have a structure in a form of one layer or laminated layers of fiber meshes, wire meshes, filter papers, meshes, foamed metal structures, or fluorine-based plastic or polymeric films for condensing or capturing moisture on the surface of the structure. The moisture removal unit has a material being one selected from a group consisting of a first metal material, a plastic material and a combination thereof. The first metal material is a foamed nickel (also called a nickel foam or a porous nickel) or stainless steel, the plastic material is a second teflon material or a polyolefin. The second teflon material is one selected from a group consisting of polytetrafluoroethylene (PTFE), fluorinated ethylene propylene (FEP), perfluoroalkoxy alkanes (PFA), polyvinylidene difluoride (PVDF) and a combination thereof. The polyolefin material is polypropylene (PP). When the moisture removal unit is a metal fiber or a metal mesh (such as a stainless steel fiber or a stainless steel mesh), it has a density of 80 kg/m³-400 kg/m³, and has a porosity of more than 90%. When the moisture removal unit is a foamed nickel, it has a density of 100 kg/m³-500 kg/m³. For example, when a foamed nickel has an area density of 0.0583 g/cm³ and a thickness of 0.4 cm, its density can be calculated as 0.0583/0.4=0.1458 g/cm³, namely 145.8 kg/m³, and the moisture removal unit has a porosity being more than 90%. When the second teflon material has a density of 300 kg/m³-700 kg/m³, the moisture removal unit has a porosity being more than 70%. When the moisture removal unit is a fiber mesh, which has a material of the polyolefin, such as PP, it has a wire diameter of 0.1 to 0.3 mm, a warp density of 40 to 80 threads/inch, a weft density of 40 to 80 threads/inch, and a porosity of more than 70%.

When the moisture removal unit has the first metal material, it has a porosity greater than or equal to 90%; and when the moisture removal unit has the plastic material, the moisture removal unit has a porosity greater than or equal to 70%.

The material of the cathode 201 includes a catalyst, a conductive agent and an adhesive. The catalyst includes a metal or a metal oxide. The metal is at least one selected from a group consisting of platinum (Pt), gold (Au), ruthenium (Ru) and iridium (Ir). The metal oxide is at least one selected from a group consisting of iridium dioxide (IrO₂), ruthenium dioxide (RuO₂), cobalt monoxide (CoO), tricobalt tetroxide (Co₃O₄), manganese dioxide (MnO₂), nickel hydroxide (Ni(OH)₂), tungsten trioxide (WO₃), vanadium pentoxide (V₂O₅), palladium oxide (PdO), nickel monoxide (NiO) and diiron trioxide (Fe₂O₃). The material of the conductive agent includes a carbon material selected from a group consisting of carbon black, acetylene black or carbon nanofiber. The adhesive includes a third teflon material, and the third teflon material is one selected from a group consisting of polytetrafluoroethylene (PTFE), fluorinated ethylene propylene (FEP), perfluoroalkoxy alkanes (PFA) and polyvinylidene difluoride (PVDF).

The material of the anode 202 includes a second metal material, a second metal oxide material, or a combination thereof. Due to the material properties of the cathode 201 (as described above in relation to FIGS. 6 and 6B), reverse leakage of the electrolyte 203 from the inlet 207 can be avoided.

The anode 202 has an anode material selected from a group consisting of a second metal, a second metal oxide, and a combination thereof, the second metal is one selected from a group consisting of nickel (Ni), platinum (Pt), gold (Au), ruthenium (Ru), iridium (Ir) or iron (Fe), and the second metal oxide is an oxide of the second metal.

It should be noted that, the method for obtaining new-born oxygen using the wet-type device for obtaining newly generated oxygen from the atmospheric environment according to the present invention is different from the normally-used method for generating oxygen by electrolyzing water, even though both methods use electrochemical reactions to generate oxygen. The present invention use a method that does not directly electrolyze water. The method is achieved by taking the oxygen from the atmospheric environment as a source, and utilizing the electrochemical reactions as above-described in the present invention to generate hydroxy ions from oxygen by a first electrochemical reaction, i.e. a reduction reaction, occurring at the cathode, and to generate the newly generated oxygen from the hydroxy ions by a second electrochemical reaction, i.e., the oxidation reaction, occurring at the cathode.

The material of the cathode 201 of the present invention only reacts with oxygen and does not react with nitrogen. Please Refer to FIG. 7 again, the oxygen existing in the atmospheric environment enters the container 204 shown in FIG. 7 from the inlet 207 through the cathode 201 (the direction of entry of the oxygen existing in the atmospheric environment is shown by the direction of the arrows adjacent to the inlet 207 as shown in FIG. 7), and is adsorbed in the gaps and pores in the cathode 201. The first electrochemical reaction occurs at the cathode 201, wherein the electrons required by the reaction occurring the cathode 201 are supplied by a power supply (not shown in the drawing) through an external circuit (not shown in the drawing) from the anode 202 to the cathode 201, and the hydroxide ions generated at the cathode 201 are diffused to the anode 202 and are oxidized by the second electrochemical reaction to generate newly generated oxygen. Because the newly generated oxygen is in a form of bubbles, and its density is lower than that of the electrolyte 203, it emerges from the anode 202, floats up through the electrolyte 203 naturally, passes through the moisture removal unit 205 and the gas permeable element 206 both disposed above the electrolyte 203, and is output from the outlet 208 (the direction of output is shown by the arrow above the outlet 208 as shown in FIG. 7). The water consumed in the first electrochemical reaction occurring at the cathode is in stoichiometric equilibrium with the water produced in the second electrochemical reaction occurring at the anode. Therefore, the water in the electrolyte 203 is not consumed by the electrochemical reactions at all. In addition, if the water in the electrolyte 203 volatilizes to form water vapor, the water vapor can be condensed through the moisture removing structure 205 and will not be output through the outlet 208 along with the newly generated oxygen. The water in the electrolyte 203 will not be lost, so that the concentration of the composition of the electrolyte 203 varies to a very small extent. Therefore, the service life of the wet-type device 200 for obtaining newly generated oxygen from the atmospheric environment according to the present invention can be effectively prolonged. In addition, the gas permeable element 206 also has a function of isolating the water vapor and the electrolyte 203 from passing therethrough, and solving the problem of water evaporation (or what is called a water-poor problem).

FIG. 8 is a schematic drawing showing a device for preventing a liquid passing therethrough according to an embodiment of the present invention. As shown in FIG. 8, the device 300 for preventing a liquid from passing therethrough has an inlet section 301 having an inlet 307, a moisture removal unit section 302, a moisture removal unit outlet section 303 having an internal outlet channel 309, a gas permeable element 306, and an outlet section 304. Each sections of the device 300 can be manufactured separately and assembled together after all sections are manufactured. The inlet 307 allows the inflow of air in the atmospheric environment (as shown by the arrows). The outlet 308 allows the outflow of air (as shown by the arrow), and the moisture removal unit 305 accommodated in the moisture removal unit section 302 which allows the air flowing through the outlet 308 and prevents the moisture or liquid in the air passing therethrough. According to an embodiment of the present invention, the gas permeable element 36 is disposed closest to the position of the outlet 308, and the moisture removal unit 305 is disposed adjacent to the inlet 307. When the air with the moisture coining from the atmospheric environment enters the device 300 for preventing a liquid from passing therethrough, the moisture in the air is blocked by the moisture removing structure 305 and is condensed into liquid phase water, and the condensed water flows downward due to gravity and flows out of an outlet (not shown) additionally disposed at the bottom of the moisture removal unit 305. According to another embodiment of the present invention, in the case that the moisture removal unit 305 is installed with a rotation of 90 degree so that the outlet 308 faces upward and the inlet 307 faces downward, the condensed water flows out from the inlet 307 due to gravity. Accordingly, because the moisture in the air is removed, the dry air passes through the internal outlet channel 309 inside the moisture removal unit section 302 and through the gas permeable element 306, and is subsequently output through the outlet 308.

The device 300 for preventing a liquid passing therethrough which includes a moisture removal unit and a gas permeable element can be independently attached externally to the top of an electrolytic device containing a cathode 201, an anode 202, and an electrolyte 203 as shown in FIG. 7, or is externally connected to a dry-type apparatus such as a molecular sieve that can adsorb nitrogen and separate oxygen from air in the atmospheric environment, or can includes the dry-type apparatus to form a dry type device for obtaining newly generated oxygen from the atmospheric environment.

In another embodiment according to the present invention, a device for obtaining a newly generated oxygen from an atmospheric environment includes an oxygen generating unit, a container having an outlet and accommodating therein the oxygen generating unit; a moisture removal unit disposed in the container; and a gas permeable element disposed at the outlet, wherein the gas permeable element is disposed at a position closer to the outlet than the moisture removal unit.

The oxygen generating unit is one of a wet oxygen generating unit and a dry oxygen generating unit, the wet oxygen generating unit includes a cathode, an anode and an electrolyte, and the dry oxygen generating unit includes a molecular sieve. The wet oxygen generating unit is configured to be in contact with and react with an environmental air in the atmospheric environment.

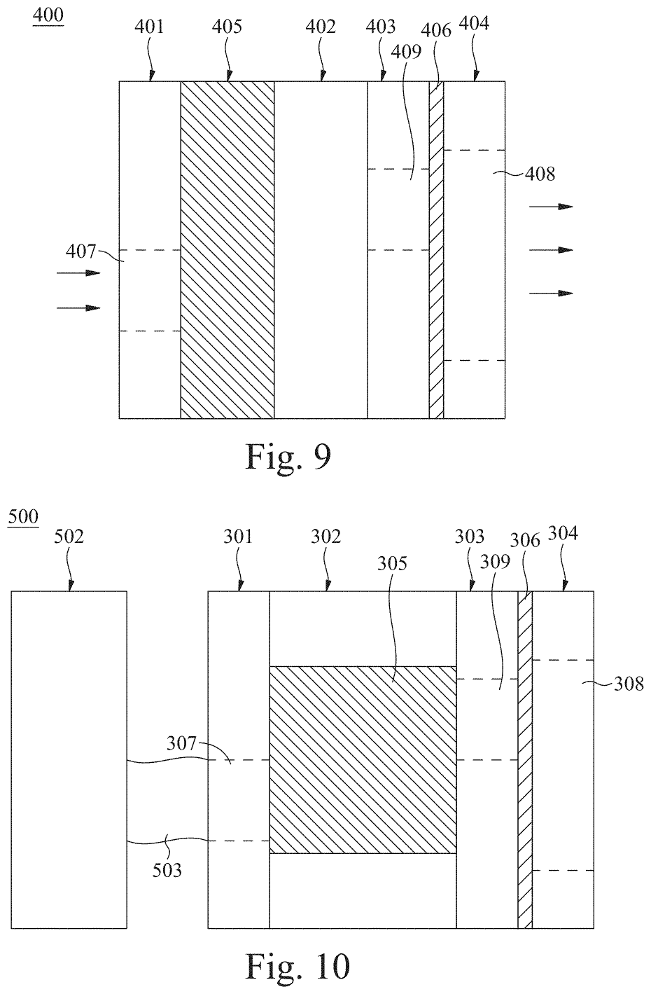

FIG. 9 is a schematic drawing showing a dry-type device for obtaining newly generated oxygen from an atmospheric environment according to an embodiment of the present invention. As shown in FIG. 9, the dry-type device 400 for obtaining newly generated oxygen from the atmospheric environment has an inlet section 401 having an inlet 407, a moisture removal unit 405, a dry-type device 402 for separating oxygen, and an outlet section 403 of the dry-type device 202 (which has an internal outlet channel 409), an air permeate element 406, and an outlet section 404 having an outlet 408. Each section of the device can be separately manufactured and assembled together after being manufactured. The inlet 407 allows the inflow of air coining from the atmospheric environment (as indicated by the arrows) and the outlet 408 allows the outflow of the newly generated oxygen (as indicated by the arrow). According to an embodiment of the present invention, the gas permeable element 406 is disposed closest to the outlet 408, and the moisture removal unit 405 is disposed adjacent to the inlet 407.

The dry-type device 402 separating oxygen from air can be, but is not limited to, a molecular sieve. A molecular sieve includes a zeolite material. There are four pore sizes including 3 Å, 4 Å, 5 Å, and 13 Å generally available for the zeolite material. The molecular sieve utilizes physical adsorption and desorption techniques, with the appropriate selection of the pore size, to separate the oxygen and nitrogen from the air coining from the atmospheric environment. A molecular sieve has two operation modes to separate oxygen from air. The first operating mode is that the molecular sieve adsorbs nitrogen in the air under a high pressure applied by a pressurizing device (which is not shown in the drawing), so that the newly generated oxygen is collected in a high concentration from the atmospheric environment. The adsorbed nitrogen under the high pressure is then released back to the atmospheric environment from a discharge device (which is not shown in the drawing) of the molecular sieve. The molecular sieve itself is not consumed and can continue to be separated the oxygen from the air in the atmospheric environment. The second operation mode is that the molecular sieve adsorbs oxygen from the air and discharges nitrogen (which is not shown in the drawing). For example, a molecular sieve with a pore size of 3 Å is selected to adsorb oxygen molecules with a molecular size of about 3.8 Å×2.8 Å, while the nitrogen molecules of about 4.2 Å pass therethrough without being adsorbed. After a plurality of cycles of separating the oxygen and the nitrogen from the air are performed, a high concentration of the newly generated oxygen can be obtained accordingly.

FIG. 10 is a schematic drawing showing a dry-type device for obtaining newly generated oxygen from an atmospheric environment according to another embodiment of the present invention. As shown in FIG. 10, a dry-type device 500 for obtaining oxygen from the atmospheric environment according to the present invention includes a dry-type device 502 for separating the oxygen from the air and the device 300 for preventing a liquid passing therethrough as shown in FIG. 8 is externally connected thereto. The dry-type device 502 for separating the oxygen from the air can be, but is not limited to, a molecular sieve as the dry-type device 402 for separating the oxygen from the air as previously described.

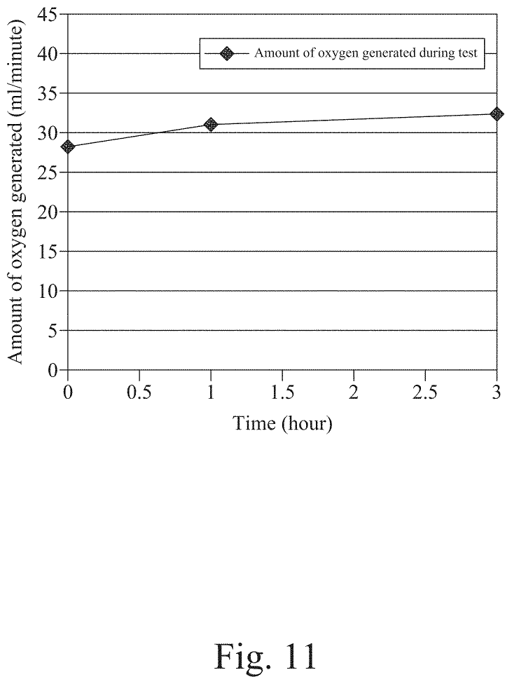

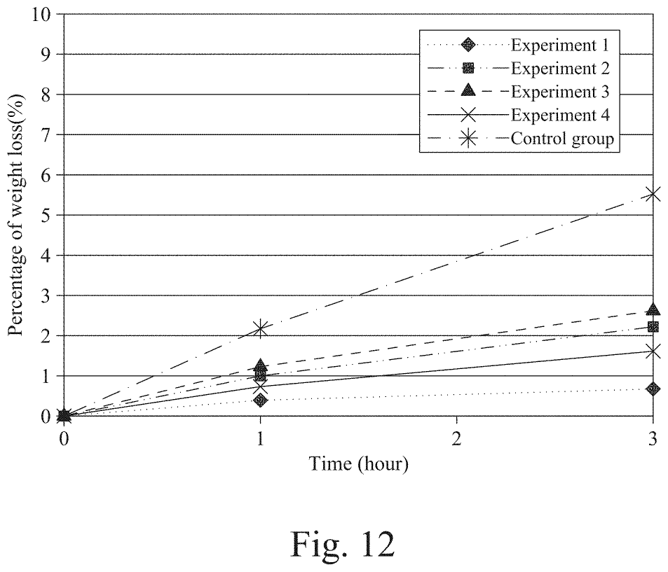

FIG. 11 is a graph showing the amounts of the oxygen generated using the wet-type device for obtaining newly generated oxygen from the atmospheric environment under the conditions for the moisture removal test according to the present invention. FIG. 12 is a graph showing moisture loss curves of the moisture removal test using the wet-type device for obtaining newly generated oxygen from the atmospheric environment according to the present invention. The test conditions for the moisture removal unit are shown in Table 8. The test was carried out under the conditions with an applied current density of 60 mA/cm² accompanying with the same conditions as those for testing the amount of the oxygen generated as shown in FIG. 11. As what is shown in FIG. 11, the test was started from 0 to 3 hours, and the amount of the oxygen generated was maintained at approximately 30 mL/min.

TABLE 8

| | | Experiment 1 | Experiment 2 |
|---|---|---|---|
| cathode | catalyst | MnO₂ 270 μm: 20% | same as |
| | | MnO₂ 5 μm: 4% | Experiment 1 |
| | conductive | XC72: 46% | same as |
| | agent | | Experiment 1 |
| | adhesive | PTFE: 30% | same as |
| | | | Experiment 1 |
| | solvent | water | same as |
| | | | Experiment 1 |

| | | |
|---|---|---|
| Anode | Ni mesh | IrO₂ mesh |
| electrolyte | 30% NaOH | 30% K₂CO₃ |
| Aie permeable | PTFE | PTFE |
| element | membrane | membrane |
| | pore size: | pore size: |
| | 5 μm | 0.1 μm |
| | thickness: | thickness: |
| | 170 μm | 30 μm |
| moisture | metal plate of | stainless mesh |
| removal unit | foamed nickle | density: |
| | density: | 80 kg/m³ |
| | 500 kg/m³ | |

| | | | | Control |
|---|---|---|---|---|
| | | Experiment 3 | Experiment 4 | group |
| cathode | catalyst | same as | same as | same as |
| | | Experiment 1 | Experiment 1 | Experiment 1 |
| | conductive | same as | same as | same as |
| | agent | Experiment 1 | Experiment 1 | Experiment 1 |
| | adhesive | same as | same as | same as |
| | | Experiment 1 | Experiment 1 | Experiment 1 |
| | solvent | same as | same as | same as |
| | | Experiment 1 | Experiment 1 | Experiment 1 |

| | | | |
|---|---|---|---|
| Anode | Ni mesh | Ni mesh | Ni mesh |
| electrolyte | 30% K₂CO₃ | 30% KOH | 30% NaOH |
| Gas permeable | PTFE | PTFE | none |
| element | membrane | filter paper | |
| | pore size: | pore size: | |
| | 5 μm | 5 μm | |
| | thickness: | thickness: | |
| | 170 μm | 500 μm | |
| moisture | PTFE filter | PP fiber | None |
| removal unit | paper | mesh | |
| | Density: | wire | |
| | 500 kg/m³ | diameter: | |
| | | 0.18 mm | |
| | | warp and weft | |
| | | density: 42 | |
| | | thread/inch | |

As shown in FIG. 12, which shows test result showing the percentage of weight loss of the electrolyte for each of Experiments 1-4 and the control group using the device for obtaining a newly generated oxygen from an atmospheric environment, which had the device for preventing a liquid from passing therethrough including the gas permeable element and the moisture removal unit. The weight of the electrolyte was measured at the time points of 0 hour (i.e. before the test), 1 hour, and 3 hours. The weight loss of the electrolyte was calculated at each time point, and then converted to the percentage of weight loss relative to the weight before the test. The weight loss of the electrolyte weight resulted from the escape of moisture from the electrolyte. It can be seen from the curve in FIG. 12 that, for example, in the control group performed without using the device for preventing a liquid passing therethrough according to the present invention, the percentage of the weight loss of the electrolyte exceeded 2% at the time of 1 hour and exceeded 5% at the time of 3 hours. In contrast, in Experiments 1, 2, 3, and 4 performed using the device for preventing a liquid from passing therethrough according to the present invention, it showed that the percentage of the weight loss for each of the Experiments 1-4 is much lower than that of the control group. It can be easily verified that the device for preventing a liquid passing therethrough according to the present invention can be applied to a wet-type device for obtaining newly generated oxygen from the atmospheric environment, and has an excellent effect of preventing the moisture from escaping.

Of course, the device 300 for preventing a liquid from passing therethrough according to the present invention can be applied to a dry-type device for obtaining a newly generated oxygen from an atmospheric environment. The effect achieved by the dry-type device can also be deduced and verified from the above test data.

While the invention has been described in terms of what is presently considered to be the most practical and preferred embodiments, it is to be understood that the invention need not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A device for obtaining a newly generated oxygen from an atmospheric environment, comprising:
a container having an inlet and an outlet;
a cathode accommodated in the container and being in contact with an environmental oxygen in the atmospheric environment;
an anode accommodated in the container and disposed at a position opposite to the cathode;
an electrolyte accommodated in the container and immersing therein the cathode and the anode;
a moisture removal unit disposed at the outlet having an outlet position; and
a gas permeable element disposed at the outlet,
wherein the cathode is disposed at the inlet and the gas permeable element is disposed at a position closer to the outlet position than the moisture removal unit.

2. The device according to claim 1, wherein the device further comprises a power supply connected to the cathode and the anode, the cathode is configured to adsorb the environmental oxygen, the environmental oxygen is adsorbed to generate an hydroxy ion by a first electrochemical reaction at the cathode, and the hydroxy ion is to generate the newly generated oxygen by a second electrochemical reaction.

3. The device according to claim 1, wherein:
the gas permeable element has a material being a first teflon material selected from a group consisting of PTFE, FEP and PVDF; and
the moisture removal unit has a material being one selected from a group consisting of a first metal material, a plastic material and a combination thereof.

4. The device according to claim 3, wherein the first metal material is one of a foamed nickel and a steel, and the plastic material is one of a second teflon material and a polyolefin.

5. The device according to claim 4, wherein the second teflon material is one selected from a group consisting of PTFE, FEP, PFA, PVDF and a combination thereof, and the polyolefin is PP.

6. The device according to claim 4, wherein:
when the moisture removal unit has the first metal material, the moisture removal unit has a porosity greater than or equal to 90%; and
when the moisture removal unit has the plastic material, the moisture removal unit has a porosity greater than or equal to 70%.

7. The device according to claim 4, wherein when the moisture removal unit has the plastic material, the gas permeable element has a pore size ranging from 0.1 μm to 10 μm and a thickness ranging from 30 μm to 300 μm.

8. The device according to claim 1, wherein the cathode has a material comprising a catalyst, a conductive agent and an adhesive.

9. The device according to claim 1, wherein:
the catalyst includes one of a metal and a metal oxide;
the metal is one selected from a group consisting of Pt, Au, Ru, Ir and a combination thereof;
the metal oxide is at least one selected from a group consisting of IrO2, RuO₂, CoO, Co₃O₄, MnO₂, Ni(OH)₂, WO₃, V₂O₅, PdO, NiO and Fe₂O₃;
the conductive agent includes a carbon material selected from a group consisting of carbon black, acetylene black or carbon nanofiber; and
the adhesive includes a third teflon material, wherein the third teflon material is one selected from a group consisting of PTFE, FEP, PFA and PVDF.

10. The device according to claim 1, wherein the anode has an anode material selected from a group consisting of a second metal, a second metal oxide, and a combination thereof, the second metal is one selected from a group consisting of Ni, Pt, Au, Ru, Ir and Fe, and the second metal oxide is an oxide of the second metal.

11. A device for obtaining a newly generated oxygen from an atmospheric environment, comprising:
an oxygen generating unit;
a container having an outlet and accommodating therein the oxygen generating unit;
a moisture removal unit disposed in the container; and
a gas permeable element disposed at the outlet, wherein:
the gas permeable element is disposed at a position closer to the outlet than the moisture removal unit.

12. The device according to claim 11, wherein:
the gas permeable element has a material being a first teflon material selected from a group consisting of PTFE, FEP and PVDF; and
the moisture removal unit has a material being one selected from a group consisting of a first metal material, a plastic material and a combination thereof.

13. The device according to claim 12, wherein the plastic material is one of a second teflon material and a polyolefin, the second teflon material is one selected from a group consisting of PTFE, FEP, PFA, PVDF and a combination thereof, and the polyolefin is PP.

14. The device according to claim 12, wherein:
when the moisture removal unit has the first metal material, the moisture removal unit has a porosity greater than or equal to 90%; and
when the moisture removal unit has the plastic material, the moisture removal unit has a porosity greater than or equal to 70%.

15. The device according to claim 11, wherein the oxygen generating unit is one of a wet oxygen generating unit and a dry oxygen generating unit, the wet oxygen generating unit comprises a cathode, an anode and an electrolyte, and the dry oxygen generating unit comprises a molecular sieve.

16. The device according to claim 15, wherein the wet oxygen generating unit is configured to be in contact with and react with the atmospheric environment.

17. A device for preventing a liquid from passing therethrough, comprising:
a liquid removal structure; and
a gas permeable element configured to be connected to the liquid removal structure.

18. The device according to claim 17, wherein:
the gas permeable element has a material being a first teflon material selected from a group consisting of PTFE, FEP and PVDF; and
the liquid removal structure has a material being one selected from a group consisting of a first metal material, a plastic material and a combination thereof.

19. The device according to claim 18, wherein the plastic material is one of a second teflon material and a polyolefin, the second teflon material is one selected from a group consisting of PTFE, FEP, PFA, PVDF and a combination thereof, and the polyolefin is PP.

20. The device according to claim 18, wherein:
when the liquid removal structure has the first metal material, the liquid removal structure has a porosity greater than or equal to 90%; and
when the liquid removal structure has the plastic material, the liquid removal structure has a porosity greater than or equal to 70%.
